(19) United States
(12) Patent Application Publication
(10) Pub. No.: US 2025/0108366 A1
(43) Pub. Date: Apr. 3, 2025

(54) PRE-REGENERATED COUNTERCURRENT REGENERATION PROCESS

(71) Applicant: Dripping Wet Water Inc., San Antonio, TX (US)

(72) Inventors: Allison SAMPSON, San Antonio, TX (US); Richard Sampson, San Antonio, TX (US)

(73) Assignee: Dripping Wet Water Inc., San Antonio, TX (US)

(21) Appl. No.: 18/899,092

(22) Filed: Sep. 27, 2024

Related U.S. Application Data
(60) Provisional application No. 63/587,617, filed on Oct. 3, 2023.

(51) Int. Cl. B01J 49/06; B01J 47/02; B01J 49/53; B01J 49/60; C02F 1/42

(52) U.S. Cl. CPC B01J 49/06; B01J 47/02; B01J 49/53; B01J 49/60; C02F 1/42; C02F 2001/422; C02F 2001/425; C02F 2303/16

(57) ABSTRACT

A method of regenerating an ion exchanger which is used to treat a solution introduced to the ion exchanger in a downward charging direction. The ion exchanger includes a non-constrained ion exchange bed of ion exchange material in the form of ion exchange granules or beads and has a concentration profile through the ion exchange material after the solution has been introduced to the ion exchanger in the charging direction. The method of one embodiment includes passing a pre-regenerating solution downwardly through the non-constrained ion exchange bed of ion exchange material in an intermittent pulsed flow of a pulse or downflow of pre-regenerating solution and a subsequent non-flow pause time, followed by passing a regenerating solution upwardly through the non-constrained ion exchange bed of ion exchange material in an intermittent pulsed flow of a pulse or up flow of regenerating solution and a subsequent non-flow pause time, followed by a downflow pulse. The duration and velocity of the downward pulse of pre-regenerating solution is sufficient to partially regenerate the ion exchange material. The duration of the subsequent non-flow pause time is of short duration to allow for increased contact time of the pre-regenerating solution with the ion exchange granules or beads. The duration and velocity of the upward pulse of regenerating solution is sufficient to hydrodynamically lift the ion exchange granules a controlled distance through all of the ion exchange granules without causing significant mixing of ion exchange granules between different layers of ion exchange material. The duration of the subsequent non-flow pause time is of short duration to allow for some perceptible settling of the ion exchange granules, with the down flow pulse being sufficient to reduce the settling time of the ion exchange granules to a fraction of the normal settling time for the granules in the absence of the down flow pulse.

### CROSS-REFERENCE TO RELATED APPLICATIONS

This application claims the benefit of priority to U.S. Provisional Application for Patent No. 63/587,617, filed Oct. 3, 2023.

### BACKGROUND OF THE INVENTION

### 1. Field of the Invention

The present invention relates to an improved process for regenerating ion exchange materials, and more specifically, to a process for carrying out the regeneration using a partially pre-regenerated countercurrent technique.

### 2. Description of Related Art

U.S. Pat. No. 5,108,616 to Kunz entitled “Process for Ion Exchangers, Particularly for Regeneration After Softening and Demineralization of Aqueous Solutions,” which describes the Kunz countercurrent regeneration process, is incorporated herein for reference. U.S. Pat. No. 5,348,659 to Kunz, Dimotsis, and Sampson (hereinafter referred to as “KDS”) entitled “Countercurrent Regeneration Process,” which describes an improved process for the original Kunz countercurrent regeneration process, is also incorporated herein for reference.

Kunz describes co-current (downward) regeneration in the “Background Art” section of the patent. As such, Kunz describes the concentration profile of the ion exchange bed of a softener when exhausted, referencing higher concentration of calcium ions at the top of the ion exchange bed and lower concentration of calcium ions in the lowermost portion of the bed. Kunz then points out, “The lower the concentration of calcium ions in the lowermost ion exchange layer, which is the last one through which the water to be treated flows, the lower the residual hardness in the product water, i.e., the better the quality.” Kunz then describes the drawbacks of co-current regeneration. “During the subsequent regeneration in a co-current system, the calcium ions highly enriched in the upper ion exchanger layers are eluted from the resin by the regenerating solution and washed into the lower layers. In order to confer to these lower layers a good state of regeneration, the entire ion exchanger must be treated with a large excess of regenerating agent. These excess amounts are not fully utilized and represent a major economic loss. Furthermore, these excesses get into the sewage and increase the salt levels in the sewers. The excess sodium and chloride ions of the unused regenerate are environmentally detrimental.”

The Kunz countercurrent regeneration invention describes the regeneration of a non-constrained bed of ion exchange materials in a countercurrent fashion by admitting the regenerating solution using alternating pulse flow and non-flow conditions. During the non-flow period, the bed of ion exchange material, which is lifted during the up-flow pulse period, is allowed to settle. In the Kunz process, the pulse flow velocities and volumes, and the settle times (non-flow period) between pulses are carefully defined. Kunz further describes eight advantages to the process. These are (by summary)
1. There exists essentially no stirring of the ion exchange bed, so the concentration profile of the ion exchange bed remains intact.
2. A uniform liquid distribution is created throughout the ion exchange bed.
3. A stable plug flow is achieved for the sequence of the intermittent pulse flows throughout the entire regenerative and rinsing treatments of the ion exchanger.
4. Channeling and aggregation within the ion exchange bed are eliminated and any accumulated fines within the bed are dislodged and discharged.
5. The efficiency of the regeneration is improved.
6. Ionic leakage and regeneration waste are reduced.
7. Rinse water requirements are reduced.
8. No special equipment is required.

Although these advantages are substantial, the Kunz process requires extended regeneration periods to accommodate the settling time (non-flow periods), which render the process limited commercially.

In order to overcome the time constraint of Kunz, the KDS patent describes the invention of an improved Kunz process by reducing the overall time for the regeneration of an ion exchanger while maintaining the basic regenerating chemical utilization advantage of Kunz. KDS describes an up-flow pulse of duration and volume according to Kunz followed by a down-flow pulse to initiate bed settling followed by a non-flow period settling time to complete the bed settling to the degree required by Kunz. With the KDS improved process, the time to regenerate was reduced by over 35%.

Nonetheless, despite the advances of prior art methods such as those of Kunz and KDS, there remains a need for even further reduction in the total time required for complete regeneration, yet while maintaining an acceptable level of regeneration efficiency, so as to make the process even more attractive for commercial applications.

### SUMMARY OF THE INVENTION

It has now been discovered by the present inventors that the Kunz and KDS processes can be improved by significantly reducing the total time of regeneration by partially pre-regenerating the ion exchange bed with a pre-regenerating solution (which is the same solution used as the regenerating solution) in a downflow manner. This pre-regenerating of the ion exchange bed dramatically reduces the total time required for complete regeneration under the Kunz and KDS processes, while maintaining the basic regenerating chemical utilization advantages of the Kunz process.

It is therefore an object of the present invention is to provide an improved countercurrent ion exchange regeneration process.

It is another object of the present invention to provide a regeneration process that improves upon the Kunz and KDS processes by reducing the overall time for the regeneration of an ion exchanger.

It is still another object of the present invention to provide a regeneration process that reduces the overall time for the regeneration while maintaining the basic regenerating chemical utilization advantage of the original Kunz process.

And, it is still another object of the present invention to provide a regeneration process that is economically attractive by virtue of employing a pre-regenerating solution.

With these and other objects in mind, the present invention advantageously relates to a pre-regenerated countercurrent regeneration process. To solve the prior art problem of still substantially lengthy regeneration times, the present invention significantly reduces the total time of regeneration by partially pre-regenerating the ion exchange bed with a pre-regenerating solution in a downflow manner.

Furthermore, advantageously, the pre-regenerating solution can be the same solution as is used as the regenerating solution.

And, by virtue of partially pre-regenerating the ion exchange bed with the pre-regenerating solution in a downflow manner, the present invention maintains an acceptable level of regeneration efficiency.

More specifically, with the present invention, a downflow (co-current) pulse of predetermined duration and volume followed by a corresponding no-flow period is used to introduce pre-regenerating chemical into the ion exchange bed in order to partially pre-regenerate the bed with the pre-regenerating chemical. Once the ion exchange bed is partially pre-regenerated in a downflow manner with the pre-regenerating chemical, a series of up-flow pulses of a duration and volume according to Kunz is employed to introduce regenerating chemical in an upward direction sufficient to hydrodynamically lift the bed a controlled distance without causing mixing of the ion exchange materials while pushing the pre-regenerating chemical through the bed in an up-flow manner. This up-flow pulse is followed by a downflow pulse to initiate bed settling followed by a no-flow settle time to complete bed settling to the degree required by Kunz, according to KDS.

In a further embodiment of the present invention, the up-flow pulse is followed by a no-flow settle time to start bed settling, which, in turn, is followed by a downflow pulse to complete bed settling to the extent required by Kunz. The cycle is then repeated with the introduction of another up-flow pulse, according to KDS.

In a further embodiment of the present invention, the up-flow pulse is followed by a no-flow settle time. The cycle is then repeated with the introduction of another up-flow pulse. The foregoing objects and advantages together with other objects and advantages which will become subsequently apparent reside in the details of construction and operation as more fully hereinafter described, reference being had to the accompanying drawings forming a part hereof, wherein like reference numbers refer to like parts throughout.

### BRIEF DESCRIPTION OF THE DRAWINGS

FIG. 1 is a schematic illustration of an ion exchange vessel suitable for use in carrying out the present invention.

FIG. 2 presents Tables 1, 2, 3, 4, 5, and 6 summarizing data illustrating the advantageous effects of the present invention relative to prior art regeneration processes.

FIG. 3 presents a table summarizing data comparing processing times associated with various steps of the present invention with those of the prior art.

### DETAILED DESCRIPTION OF THE PREFERRED EMBODIMENTS

Although only preferred embodiments of the present invention are explained in detail, it is to be understood that the invention is not limited in its scope to the details of construction and arrangement of components set forth in the following description or illustrated in the drawings. As described hereinafter, the present invention is capable of other embodiments and of being practiced or carried out in various ways.

Also, for the purposes of this specification, including the appended claims, certain terminology will be resorted to for the sake of clarity in describing the preferred embodiments. It is intended that each term contemplates its broadest meaning as understood by those skilled in the art, and includes all technical equivalents which operate in a similar manner to accomplish a similar purpose.

As may be used herein, for the purposes of this specification, including the appended claims, the meaning of the terms “about” and “approximately,” when modifying numbers expressing any of a number of sizes, dimensions, portions, shapes, formulations, parameters, percentages, quantities, characteristics, and other numerical values used in the specification and claims, is intended to encompass the stated value plus or minus 10%.

In order to understand the present invention, the following basic description of Kunz and KDS must be considered.

In accordance with the process disclosed by Kunz, a non-constrained bed of ion exchange material, charged by downward flow, is first treated with regenerant (i.e., regenerating solution) and then with rinse solution feeding these solutions through the ion exchange materials in a direction opposite or countercurrent to the charging direction. This feed of both the regenerant and then the rinse solution is conducted in an upward flow such that the exchange materials or beads are loosened, but no mixing or rearrangement of the layers occurs in the flow direction and the regenerant and rinse solutions are then discharged above the ion exchange bed.

The ion exchange materials are loosened but not mixed or rearranged in accordance with Kunz by a process consisting of a short pulse flow followed by a subsequent settle time during which there is no flow of liquid. During the pulse flow there is hydrodynamic lifting of the ion exchange materials or beads and during the pause or settle time the materials are permitted to resettle to essentially their original position. Preferably, the pulse flow is designed to permit lifting of the exchange material but to no more than ten times the greatest grain diameter of said ion exchange materials; however, greater lifting may be permitted depending on the characteristics of the ion exchanger. The pause or settle time following each pulse flow lasts until substantially complete sedimentation of the ion exchange materials lifted during the pulse flow has occurred. Only after substantially complete sedimentation is the ion exchanger again subjected to the pulse flow of the next pulse interval.

While achieving significant economic advantages, the reliance by Kunz on gravitational settling limits the practical application of this process. KDS overcomes the shortcoming of Kunz by accelerating sedimentation without violating the other critical teachings of Kunz. This leads to significantly reduced overall regeneration times while still maintaining the regenerating chemical utilization advantages of Kunz.

KDS teaches that to achieve reduced settling time and, therefore, reduced total regeneration time, requires specific control of the sedimentation process without disturbing the overall ion exchange bed or interfering with the unrestrained movement of the ion exchange material during the up-flow portion of Kunz. KDS teaches that controlled downflow will dramatically assist the sedimentation process while preserving the other inherent advantages of Kunz. The effect of the downflow in conjunction with gravity is sufficient to dramatically reduce settle time while still allowing a net up-flow through the bed to complete the regeneration process. The downflow provides additional force over that provided by gravity, which can be applied at any time during the sedimentation process. A small addition of downflow settling force to the gravitational resettling or sedimentation process provides significant improvement to Kunz.

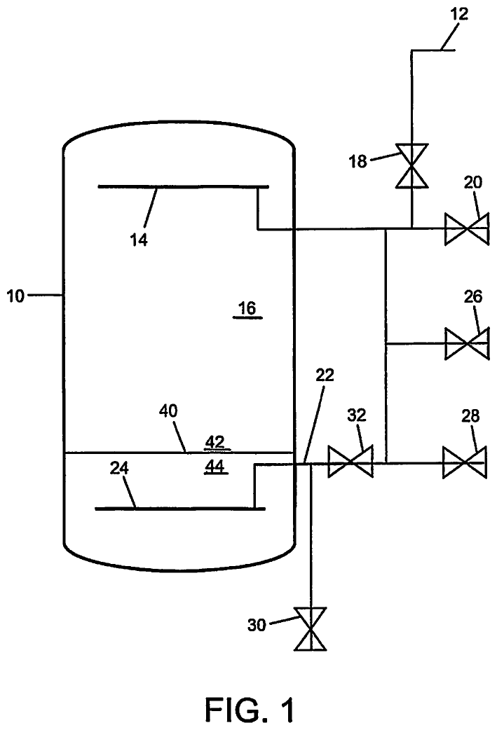

FIG. 1 illustrates an ion exchange vessel 10 with hardware suitable for carrying out the present invention. The vessel 10 contains an upper distribution system which consists of piping 12 connected to a distributor 14 having a plurality of openings or ports (not shown) for providing a flow of fluid to the ion exchange bed 16. The ion exchange bed 16 contains appropriate ion exchange material, such as, for example, resinic granules or beads. The distributor 14 is operably connected via piping 12 to valves 18, 20, and 26 at the top of the vessel 10. Vessel 10 further contains a lower distribution system which consists of piping 22 and distributor 24 equivalent to that of the upper distribution system and is operably connected via piping 22 to valves 28, 26, 30, and 32, respectively. A non-constrained ion exchange bed 16 of ion exchange material is contained within vessel 10. The non-constrained ion exchange bed 16 is divided at a division point 40 into two sections: a pre-regeneration section 42 and a lowermost ion exchange section 44.

In carrying out the process of the present invention, it should be understood that any suitable conventional apparatus, hardware, and/or control mechanisms which are available in the art may be used. For example, suitable plumbing, discharge devices, distributors, collectors, and related valves and control mechanisms which may be used to run and monitor the process of the present invention, are taught by Kunz and KDS. In carrying out the process of the present invention, it should also be understood that connections to piping 12 and 22 may be different for different types of ion exchange material, and that various configurations of connecting the piping is known to those skilled in the art. For example, the discharge from piping 22 through valve 30 may be connected to a drain when the ion exchange material of the ion exchange bed 16 is anion resin and the regenerating chemical is NaOH, or to a brine tank when the ion exchange material of the ion exchange bed 16 is cation softening resin and the regenerating chemical is brine.

In addition, in carrying out the process of the present invention it should be understood that all process protocols taught by Kunz (pulse duration and volume) and KDS (up-flow, settle, downflow protocol, up-flow, downflow, settle protocol) may be used.

Operation of an ion exchange vessel for a typical deionization process according to one embodiment of the present invention proceeds as follows.

During an exhaustion cycle, water containing undesirable ions passes through valve 20 into the vessel 10 through distributor 14, through the ion exchange bed 16, down through the lower distributor 24 and out the vessel through piping 22 through valves 32 and 28. When exhaustion is complete, valves 20, 32, and 28 are closed. A flow of pre-regenerating solution is introduced through valve 26, into and through distributor 14 downwardly through the ion exchange bed 16, specifically through the pre-regeneration section 42, to the division point at 40. Water displaced from the pre-regeneration section 42 passes through the lowermost section 44, through distributor 24 and out through piping 22 and through valve 30. This flow is preferably designed to introduce pre-regenerating chemical into the pre-regeneration section 42 of the ion exchange bed 16 in order to partially pre-regenerate the ion exchange bed 16 with the pre-regenerating chemical. Once the pre-regeneration step is complete, valve 30 is closed. A flow of regenerating chemical is introduced through valves 26 and 32, through distributor 24 upwardly though the ion exchange bed 16, through distributor 14 and out through piping 12, and through valve 18. The flow of regenerating chemical is preferably designed to permit a lifting height of no more than ten times the greatest grain diameter of the ion exchange resin, according to Kunz. Valves 26, 32, and 18 are then closed, and a pause or settle time proceeds until some settling of the ion exchange bed 16 has occurred. A downflow pulse is then generated by opening valves 20 and 30 to provide sufficient force to the ion exchange bed 16 to return it to substantially its initial position. The cycle (up-flow, settle, downflow) is repeated until the required quantity of regenerating chemical has been introduced into the system. The cycle (up-flow, settle, downflow) is then repeated with the up-flow consisting of rinse water until the remaining regenerant and displaced ions have been removed from the vessel 10. After completion of the rinse, the unit can then be placed back into service to be exhausted.

Operation of an ion exchange vessel for a typical deionization process according to a second embodiment of the present invention proceeds as follows.

During the exhaustion cycle, water containing undesirable ions passes through valve 20 into the vessel 10 through distributor 14, through the ion exchange bed 16, down through the lower distributor 24 and out of the vessel 10 through piping 22 through valves 32 and 28. When exhaustion is complete, valves 20, 32, and 28 are closed. A flow of pre-regenerating solution is introduced through valve 26, into and through distributor 14 downwardly through the ion exchange bed 16, specifically through the pre-regeneration section 42, to the division point at 40. Water displaced from the pre-regeneration section 42 passes through the lowermost section 44, through distributor 24 and out through piping 22 and through valve 30. This flow is preferably designed to introduce pre-regenerating chemical into the pre-regeneration section 42 of the ion exchange bed 16 in order to partially pre-regenerate the ion exchange bed 16 with the pre-regenerating chemical. Once the pre-regeneration step is complete, valve 30 is closed. A flow of regenerating chemical is introduced through valves 26 and 32, through distributor 24 upwardly though the ion exchange bed 16, through distributor 14 and out through piping 12, and through valve 18. The flow of regenerating chemical is preferably designed to permit a lifting height of no more than ten times the greatest grain diameter of the ion exchange resin, according to Kunz. Valves 26, 32, and 18 are then closed. A downflow pulse is then generated by opening valves 20 and 30 to provide sufficient force such that some settling of the ion exchange bed 16 occurs. Valves 20 and 30 are then closed, and a pause or settle time proceeds until the ion exchange bed 16 has returned to substantially its initial position. The cycle (up-flow, downflow, settle) is repeated until the required quantity of regenerating chemical has been introduced into the system. The cycle (up-flow, downflow, settle) is then repeated with the up-flow consisting of rinse water until the remaining regenerant and displaced ions have been removed from the vessel 10. After completion of the rinse, the unit can then be placed back into service to be exhausted.

Operation of an ion exchange vessel for a typical deionization process according to a third embodiment of the present invention proceeds as follows.

During the exhaustion cycle, water containing undesirable ions passes through valve 20 into the vessel 10 through distributor 14, through the ion exchange bed 16, down through the lower distributor 24 and out of the vessel through piping 22 through valves 32 and 28. When exhaustion is complete, valves 20, 32, and 28 are closed. A flow of pre-regenerating solution is introduced through valve 26, into and through distributor 14 downwardly through the ion exchange bed 16, specifically through the pre-regeneration section 42, to the division point at 40. Water displaced from the pre-regeneration section 42 passes through the lowermost section 44, through distributor 24 and out through piping 22 and through valve 30. This flow is preferably designed to introduce pre-regenerating chemical into the pre-regeneration section 42 of the ion exchange bed 16 in order to partially pre-regenerate the ion exchange bed 16 with the pre-regenerating chemical. Once the pre-regeneration step is complete, valve 30 is closed. A flow of regenerating chemical is introduced through valves 26 and 32, through distributor 24 upwardly though the ion exchange bed 16, through distributor 14 and out through piping 12, and through valve 18. The flow of regenerating chemical is preferably designed to permit a lifting height of no more than ten times the greatest grain diameter of the ion exchange resin, according to Kunz. Valves 26, 32, and 18 are then closed, and a pause or settle time proceeds until some settling of the ion exchange bed 16 has occurred. The cycle (up-flow, settle) is repeated until the required quantity of regenerating chemical has been introduced into the system. The cycle (up-flow, settle) is then repeated with the up-flow consisting of rinse water until the remaining regenerant and displaced ions have been removed from the vessel 10. After completion of the rinse, the unit can then be placed back into service to be exhausted.

In a preferred embodiment of the present invention, the pre-regeneration step of introducing pre-regenerating chemical is performed in downward pulses (pre-regeneration pulses) followed by a no-flow time. By pre-regenerating the ion exchange bed with downward pulses, no disturbance of the bed occurs as required by Kunz. The duration of the pulse is determined by the desired volume of pre-regenerating chemical required for the pulse and the diameter of the vessel, preferably approximating the duration and volume of the upward pulse of Kunz. The no-flow pause time can be shorter or longer than the charge pulse time, since no settling of the ion exchange bed is required. Preferably, the no-flow time is shorter than the charge pulse time in order to shorten regeneration time. The total volume of pre-regenerating chemical introduced into the ion exchange bed by the pre-regeneration pulses is less than 99% of the stoichiometric volume required to regenerate the entire ion exchange bed and preferably less than 90% of the stoichiometric volume required to regenerate the entire ion exchange bed. By pre-regenerating in a downward (co-current) manner with less than the stoichiometric volume of regenerating chemical, high concentrations of waste ions created when the pre-regenerating chemical contacts the ion exchange material are prevented from entering the lowermost portion of the ion exchange bed, thus preserving concentration profile of the ion exchange bed as required by Kunz. The pre-regenerating chemical introduced in the pre-regeneration step is then pulsed upwardly during the introduction of regenerating chemical into the ion exchange bed with the up-flow pulses of Kunz. The volume of regenerating chemical introduced with the up-flow pulses of Kunz is the volume needed to make up the stochiometric deficiency of the pre-regenerating chemical introduced in the pre-regeneration step, and to account for regeneration inefficiency, as defined by Kunz and KDS.

As taught by Kunz, when the upward pulses are introduced into the ion exchange bed, plug flow throughout the bed results, and no mixing occurs throughout the ion exchange bed. As the bottom of the ion exchange bed is hydrodynamically lifted and introduced to the regenerating chemical from the upward pulse, the pre-regenerating chemical introduced in the pre-regeneration step is moved upwardly through the ion exchange bed through the pre-regeneration section. The contact time of pre-regenerating chemical introduced during the pre-regeneration step on the ion exchange resin in the pre-regenerating section is increased, as the pre-regenerating chemical contacts the resin during the downward pre-regeneration pulse, the upward pulse of Kunz, the downward pulse of KDS (if employed), and the settling time.

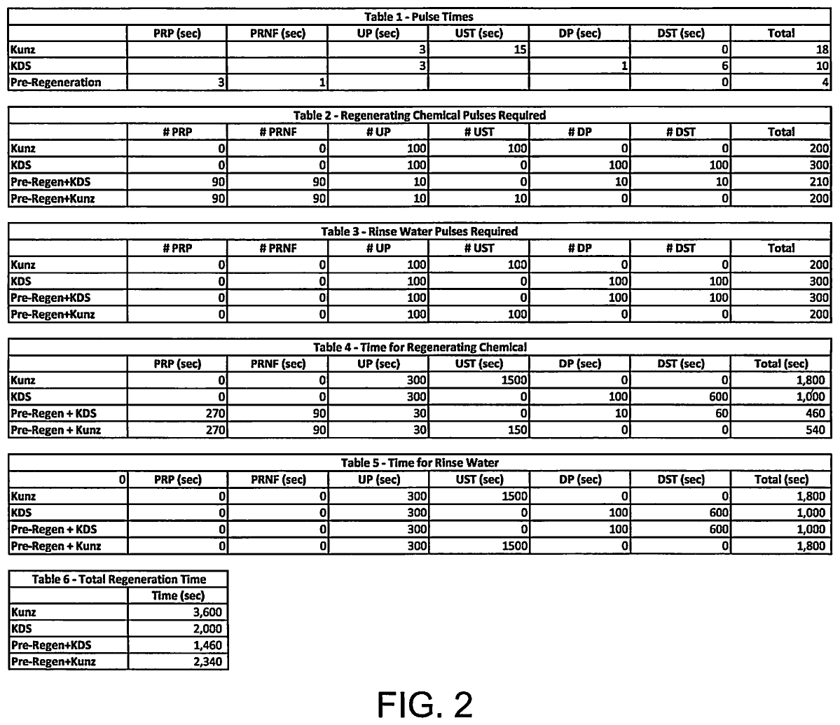

FIG. 2 presents Tables 1, 2, 3, 4, 5, and 6, which summarize data illustrating the advantageous effects of the present invention relative to prior art regeneration processes. Table 1 illustrates the pulse times for each type of pulse and pause: pre-regeneration pulse (PRP), pre-regeneration pulse non-flow time (PRNF), upward pulse (UP), upward pulse settling time (UST), downward pulse (DP), downward pulse settling time (DST). The pulse and pause times are taken from Kunz and KDS.

Table 2 illustrates the number of pulses required to introduce regenerating chemical into an ion exchange bed 300 mm tall. In the example, following the guidelines of Kunz, each upward pulse height is 3 mm, and there are 100 pulses required to introduce the regenerating chemical and completely loosen the ion exchange bed.

Table 3 illustrates the number of pulses required to introduce rinse water into an ion exchange bed 300 mm tall. In the example, following the guidelines of Kunz, each upward pulse height is 3 mm, and there are 100 pulses required to completely rinse the ion exchange bed.

Table 4 illustrates the time required to completely introduce regenerating chemical into an ion exchange bed 300 mm tall.

Table 5 illustrates the time required to completely rinse an ion exchange bed 300 mm tall.

Table 6 illustrates the time required to complete a regeneration cycle of an ion exchange bed 300 mm tall.

As is demonstrated by the data in Table 6, partially pre-regenerating the ion exchange bed results in significant time savings when regenerating ion exchange material.

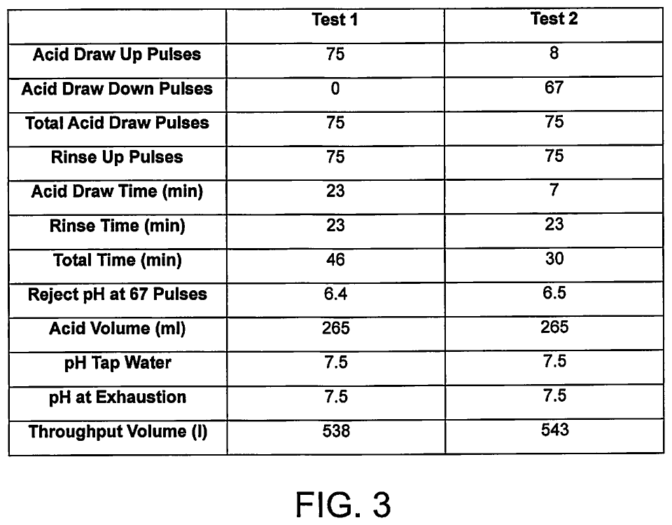

FIG. 3 presents a table summarizing data comparing processing times associated with various steps of the present invention with those of the prior art, i.e., Kunz.

### Example 1

Following the parameters of Kunz, 5 liters of cation resin was placed in a 152 mm diameter vessel such that the height of the resin therein was 228 mm. The resin was fully exhausted with tap water in a co-current flow pattern such that the pH of the inlet water and the pH of the outlet water were the same.

### Test 1

The resin in the vessel as described above was regenerated with 31% HCl per the parameters of Kunz. The resin was then fully exhausted with tap water in a co-current flow pattern such that the pH of the inlet water and the pH of the outlet water were the same.

### Test 2

The resin in the vessel as described above was regenerated with 31% HCl per the parameters of the current invention and Kunz such that 90% of the Acid Draw up pulses of Kunz were replaced by the same number of Acid Draw down pulses of the current invention. The resin was then fully exhausted with tap water in a co-current flow pattern such that the pH of the inlet water and the pH of the outlet water were the same.

### Results

The results of Test 1 and Test 2 are tabulated as shown in FIG. 3. The data demonstrates that the efficiency of regeneration is not changed when 90% of the Acid Draw up pulses of Kunz are replaced by the same number of Acid Draw down pulses of the present invention. However, advantageously, the time required for regeneration of the present invention (30 minutes) is approximately 35% less than the time required by Kunz (46 minutes).

Accordingly, as is evident from the description presented herein, the present invention provides an improved countercurrent ion exchange regeneration process. Among other advantages, the present invention improves the Kunz and KDS processes by reducing the overall time for the regeneration of an ion exchanger, while maintaining the basic regenerating chemical utilization advantage of the original Kunz process.

The foregoing descriptions and the associated drawings should be considered as being illustrative of the principles of the invention. Thus, while the invention has been described in detail with respect to specific embodiments thereof, it will be understood by those skilled in the art that variations and modifications may be made without departing from the essential features thereof.

What is claimed is:

1. A method of regenerating an ion exchanger, said method comprising:
(a) providing an ion exchanger having a non-constrained bed of ion exchange material in the form of ion exchange granules or beads;
(b) passing a solution to be treated in a downward charging direction through said bed of ion exchange material resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material in a controlled intermittent pulsed flow of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow of a pulsed up-flow of regenerating solution, a subsequent non-flow pause time, followed by a downflow pulse in a direction opposite to the up-flow, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, the duration of said subsequent non-flow pause time being in the range of about 3 to 15 seconds to allow for some perceptible settling of the ion exchange granules or beads, with said downflow pulse being sufficient to reduce the sedimentation time of said ion exchange granules or beads to a fraction of the normal gravitational settling time for said granules in the absence of said downflow pulse.

2. The method of claim 1, wherein the solution being treated according to paragraph (b) is an aqueous solution which is being softened or demineralized.

3. The method of claim 1, wherein following the treatment with the regenerating solution, all of the steps of paragraph (d) are repeated using a rinse solution.

4. The method of claim 1, wherein the solution being treated according to paragraph (b) is an aqueous solution.

5. A method of regenerating an ion exchanger, said method comprising:
(a) providing an ion exchanger having a non-constrained bed of ion exchange material in the form of ion exchange granules or beads;
(b) passing a solution to be treated in a downward charging direction through said bed of ion exchange material resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material in a controlled intermittent pulsed flow of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow of a pulsed up-flow of regenerating solution, followed by a downflow pulse in a direction opposite to the up-flow, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, said downflow pulse being sufficient to reduce the sedimentation time of said ion exchange granules or beads to a fraction of the normal gravitational settling time for said granules in the absence of said downflow pulse, followed by a subsequent non-flow pause time in a range of about 3 to 15 seconds to allow for some perceptible settling of the ion exchange granules or beads.

6. The method of claim 5, wherein the solution being treated according to paragraph (b) is an aqueous solution which is being softened or demineralized.

7. The method of claim 5, wherein following the treatment with the regenerating solution, all of the steps of paragraph (d) are repeated using a rinse solution.

8. The method of claim 5, wherein the solution being treated according to paragraph (b) is an aqueous solution.

9. A method of regenerating an ion exchanger, said method comprising:
(a) providing an ion exchanger having a non-constrained bed of ion exchange material in the form of ion exchange granules or beads;
(b) passing a solution to be treated in a downward charging direction through said bed of ion exchange material resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material in a controlled intermittent pulsed flow of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow of a pulsed up-flow of regenerating solution, a subsequent non-flow pause time, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, the duration of said subsequent non-flow pause time sufficient to allow for essentially complete settling of the ion exchange granules or beads.

10. The method of claim 9, wherein the solution being treated according to paragraph (b) is an aqueous solution which is being softened or demineralized.

11. The method of claim 9, wherein following the treatment with the regenerating solution, all of the steps of paragraph (d) are repeated using a rinse solution.

12. The method of claim 9, wherein the solution being treated according to paragraph (b) is an aqueous solution.

13. A method of generating an ion exchanger, said method comprising:
(a) providing an ion exchanger having a non-constrained bed of ion exchange material in the form of ion exchange granules or beads, said ion exchanger being in the form of a vessel having a top distributor and a bottom distributor;
(b) passing a solution to be treated in a downward charging direction through said bed of ion exchange material from said top distributor resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material in a controlled intermittent pulsed flow from said top distributor of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow from said bottom distributor of a pulsed up-flow of regenerating solution, a subsequent non-flow pause time, followed by a downflow pulse in a direction opposite to the up-flow from said top distributor, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, the duration of said subsequent non-flow pause time being in the range of about 3 to 15 seconds to allow for some perceptible settling of the ion exchange granules or beads, with said downflow pulse being sufficient to reduce the sedimentation time of said ion exchange granules or beads to a fraction of the normal gravitational settling time for said granules in the absence of said downflow pulse.

14. A method of regenerating an ion exchanger, said method comprising:
(a) providing an ion exchanger having a non-constrained bed of ion exchange material in the form of ion exchange granules or beads, said ion exchanger being in the form of a vessel having a top distributor and a bottom distributor;
(b) passing a solution to be treated in a downward charging direction through said bed of ion exchange material from said top distributor resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material from said top distributor in a controlled intermittent pulsed flow of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow from said bottom distributor of a pulsed up-flow of regenerating solution, followed by a downflow pulse from said top distributor in a direction opposite to the up-flow from said top distributor, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, said downflow pulse being sufficient to reduce the sedimentation time of said ion exchange granules or beads to a fraction of the normal gravitational settling time for said granules in the absence of said downflow pulse, followed by a subsequent non-flow pause time in the range of about 3 to 15 seconds to allow for some perceptible settling of the ion exchange granules or beads.

15. A method of regenerating an ion exchanger, said method comprising:
(a) providing an ion exchanger having a non-constrained bed of ion exchange material in the form of ion exchange granules or beads;
(b) passing a solution to be treated in a downward charging direction through said bed of ion exchange material from said top distributor resulting in the formation of a concentration profile of ions that have been exchanged from the top to the bottom of said bed through said ion exchange material with said profile exhibiting a higher concentration of ions at the top of said bed;
(c) passing a pre-regenerating solution downwardly through the non-constrained bed of ion exchange material from said top distributor in a controlled intermittent pulsed flow of a pulsed down-flow of pre-regenerating solution and a subsequent non-flow pause time, such that the total volume of pre-regenerating solution is less than 99% of the stoichiometric volume required to completely regenerate the ion exchange material; and
(d) passing a regenerating solution upwardly through the non-constrained bed of ion exchange material in a controlled intermittent pulsed flow from said bottom distributor of a pulsed up-flow of regenerating solution, a subsequent non-flow pause time, the duration and velocity of said pulsed up-flow of regenerating solution being sufficient to hydrodynamically lift said ion exchange granules or beads a controlled distance through all of the ion exchange granules or beads without causing significant mixing of ion exchange granules or beads throughout the concentration profile of said ion exchange material, the duration of said subsequent non-flow pause time sufficient to allow for essentially complete settling of the ion exchange granules or beads.
